(19) United States
(12) Patent Application Publication
(10) Pub. No.: US 2007/0284339 A1
(43) Pub. Date: Dec. 13, 2007

(54) Plasma etching chamber parts made with EDM

(76) Inventors: David O. Moore, Brookville, OH (US); William S. Seals, Camden, OH (US); Shannon Spencer, Huber Heights, OH (US); George Diercks, Centerville, OH (US); Gary Poovey, Escalon, CA (US)

Correspondence Address: GARY POOVEY, 28557 LEMON AV, ESCALON, CA, 95320, US

(21) Appl. No.: 11/449,884

(22) Filed: Jun. 9, 2006

(51) Int. Cl. B23H 1/00

(52) U.S. Cl. 219/69.17; 219/69.11

(57) ABSTRACT

A method is disclosed for manufacturing chamber parts for plasma etching chambers involving electronic discharge machining (EDM) methods that allows silicon and other ceramic materials to be formed and drilled. Key factors disclosed relate to the clamping of such materials for the EDM machining to avoid the electrical current inhibiting influence of oxide coatings that these materials can form.

### BACKGROUND OF THE INVENTION

1. Field of the Invention

This invention relates to a manufacturing method for electrodes and other chamber parts used in the semiconductor industry using electrical discharge machining (EDM).

2. Description of the Prior Art

The electrode has in it the final entrance holes for the process gases that will be ignited by radio frequency (RF) energy to etch the substrate in a plasma etching machine. The accuracy and consistency of the electrode holes is crucial in the uniformity of the etch that will take place on the semiconductor wafer that is processed in the etching machine. Other chamber parts have holes in them that serve a vital function in the chamber such as holes that allow the pressure of the chamber to be sensed. The accuracy and consistency of these holes is also key to the quality of the etch that the semiconductor wafer experiences.

These chamber parts are made through many process steps because they are made out of hard brittle materials like silicon and silicon carbide. Some of these steps include, grinding, polishing, acid dipping, and cleaning. Some parts require bonding to a backing material that reduces the cost of the assembly. The holes or hollows in the part historically have been ultrasonically drilled, diamond drilled, and LASER drilled. When ultrasonic drilling is done in thicker material, the tool can wander and the part will have a misshapen form. Diamond drilling is slow and bits must be replaced before they are worn to insure that they do not break off in the part. Laser drilling vaporizes material and leaves heat stress in the material. Laser drilling is unsuitable for drilling deep holes because the light suffers diffraction along the prolonged wall of the hole. A smooth wall for a deep straight hole is not possible. The present invention allows EDM machining of hard materials such as silicon, silicon carbide, and ceramics. Which can be made with low resistivities, without the inaccuracies of ultrasonic drilling, the risks of diamond drill breakage, or the heat stress of LASER drilling.

U.S. Pat. No. 5,993,597 by Saito, et al., which teaches PLASMA ETCHING ELECTRODE, outlines an ultrasonic drilling method for making electrodes. Ultrasonic drilling methods suffer from holes that are tapered in shape and inaccurate in placement. Further, ultrasonic drilling will produce oblate holes instead of round holes occasionally. Plasma etching electrodes are parts that are consumed during the etching process. The cost of the manufacturing process for the electrode has an important bearing on the usefulness of that manufacturing process. Ultrasonic drilling has tooling and dressing cost that are a burden on the final cost of the plasma-etching electrode produced by that method. U.S. Pat. No. 5,993,597 also requires vacuum oven heat-treating, which adds further costs to the final product.

U.S. Pat. No. 5,498,848 by Kimihiro Wakabayashi and Noriyuki Nebashi, which teaches a METHOD AND APPARATUS FOR ELECTRIC DISCHARGE MACHINING, here included by reference, describes many features of the EDM of ceramic materials. One factor not mentioned in U.S. Pat. No. 5,498,848 is the nature of the clamping of the ceramic into the EDM machine. The METHOD AND APPARATUS FOR ELECTRIC DISCHARGE MACHINING by Wakabayashi and Nebashi discusses using kerosene for a bipolar electrolyte to carry away particles during the machining, a capacitor in the circuits with less capacitance than 5000 pF, and the importance of polarity when direct current is used. These are interesting suggestions, but the electrical path will be obstructed by resistance and impeded by stray capacitance if the clamping of the ceramic is not proper, and the efficiency of the drilling will be impaired.

U.S. Pat. No. 4,393,292, which teaches METHOD OF AND APPARATUS FOR ELECTRICAL DISCHARGE A SMALL AND DEEP HOLE INTO OR THROUGH A WORKPIECE mentions the clamping twice. In column 5 line 1 and line 14, the clamp 12 is mentioned for it is shown in FIG. 1. No characteristics of the clamp are mentioned, however. This absence of information allows the clamp to be made out of metals with characteristics that will not foster good electrical contact.

U.S. Pat. No. 4,992,639, which teaches COMBINED EDM AND ULTRASONIC DRILLING, mentions electrode clamping, but not the clamping for the ceramic piece being drilled. The clamp that is mentioned is for the electrode that is machining the hole. The electrode being clamped is mentioned in column 4, line 56, and in column 5, line 61 in FIG. 4, a clamp for the electrode numbered 61 is mentioned. No clamp for the piece to be shaped is mentioned. This absence of information allows the clamp for the piece to be manufactured out of metals with characteristics that will not foster good electrical contact.

### SUMMARY OF THE INVENTION

The PLASMA ETCHING CHAMBER PARTS MADE WITH EDM puts holes or hollows in low resistivity material by EDM. The methods and tooling being disclosed in this invention allows machining by specifying the contact between the ceramic being machined and the pole of the electrical discharge that it is attached to. The surface of ceramics forms an electrical path-inhibiting layer in air. For efficient EDM of these materials the contact between the material and the machine must conduct electricity as well as possible. The PLASMA ETCHING CHAMBER PARTS MADE WITH EDM uses electrically conductive metal contact tooling that has Rockwell Hardness of 60 or less. Metal of this hardness range overcomes the inhibiting layer and allows good contact between the ceramic to be drilled and the machine being used to do the EDM machining.

A second approach to improved EDM is to abrade the surface by rubbing with an abrasive material before using a softer metal contact tooling. The abrading of the surface removes the inhibiting layer or oxide coating on the ceramic so that the softer metal tooling can still make good electrical contact with the ceramic. The tool clamping the ceramic as disclosed in PLASMA ETCHING CHAMBER PARTS MADE WITH EDM allows excellent power flow through the drill and high efficiency EDM machining. This process avoids the inherent lack of precision in the ultrasonic drilling approach. PLASMA ETCHING CHAMBER PARTS MADE WITH EDM provides great accuracy and precision in machining ceramic materials. The PLASMA ETCHING CHAMBER PARTS MADE WITH EDM is much faster than diamond drilling, and is able to drill deep holes that laser drilling is not able to do with smooth walls because of diffraction effects.

U.S. Pat. No. 5,993,597, which teaches PLASMA ETCHING ELECTRODE, teaches inaccurate expensive hole drilling by ultrasonic methods. The methods disclosed here are more cost effective and accurate than those presented in U.S. Pat. No. 5,993,597 by Sato, et al., which teaches PLASMA ETCHING ELECTRODE, because it uses ultrasonic drilling that requires tooling and dressing cost that are a burden on the final cost of the plasma-etching electrode produced by that method. In addition this ultrasonic method lacks the precision and speed of the EDM method here disclosed.

The tooling disclosed here may be used with equipment using a capacitor many pF greater than those recommended in U.S. Pat. No. 5,498,848 which teaches METHOD AND APPARATUS FOR ELECTRIC DISCHARGE MACHINING here incorporated by reference. METHOD AND APPARATUS FOR ELECTRIC DISCHARGE MACHINING makes no mention of the importance of the clamping tooling. METHOD AND APPARATUS FOR ELECTRIC DISCHARGE MACHINING discusses at length the polarity used in EDM machining, but without good clamping and electrical content these considerations are moot. The suggestion of using kerosene is interesting, but without good clamping the machining will not be efficient. PLASMA ETCHING CHAMBER PARTS MADE WITH EDM provides great accuracy and precision in machining ceramic materials. The PLASMA ETCHING CHAMBER PARTS MADE WITH EDM is much faster than diamond drilling, and is able to drill deep holes that laser drilling is not able to do. Laser drilling has a problem in that the diffraction of light by the walls of the hole being drilled defocuses the light in long holes, and the walls will not be soothe.

U.S. Pat. Nos. 4,393,292, and 4,992,639 both mention clamping but no information is given that would allow the clamping to be effective, as the present disclosure has done. The clamping is left ineffective and will not allow the most economical and efficient methods disclosed here to be known.

### BRIEF DESCRIPTION OF THE DRAWINGS

FIG. 1 is a diagrammatic image of one style of plasma etch chamber electrode.

FIG. 2 pictures the plasma chamber part being electrical discharge machined with clamping that is making good electrical contact with the ceramic material.

### BEST MODE FOR CARRYING OUT THE INVENTION

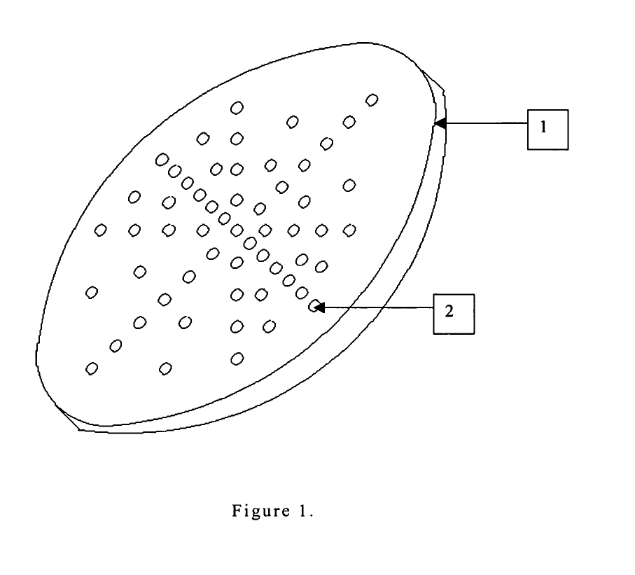

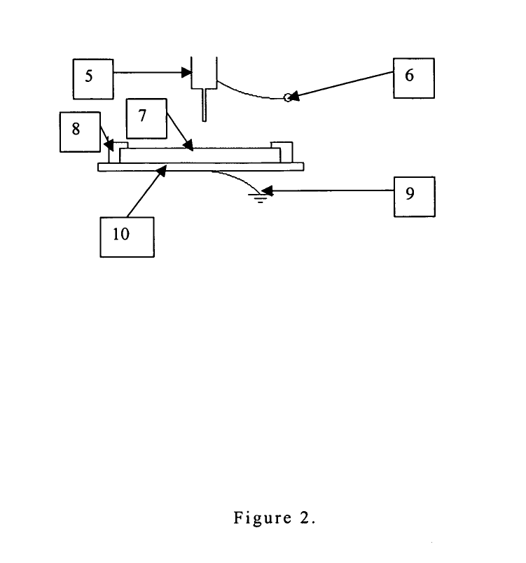

The PLASMA ETCHING CHAMBER PARTS MADE WITH EDM is associated with many steps such as grinding, polishing, acid dipping, cleaning, and occasionally bonding, but these steps are well known and familiar to any one involved with the art of dealing with hard brittle materials. This disclosure focuses on the clamping of the parts to the machine that performs the EDM function because it is absent in previous art. The PLASMA ETCHING CHAMBER PARTS MADE WITH EDM uses the characteristic of hardness in the clamping material to provide good electrical contact between the ceramic and the EDM machine. The diagrammatic image of the plasma etch camber electrode is a plate of hard brittle material numbered 1 in FIG. 1. The image has holes drawn in it. The number and position of these holes are different for different plasma chambers. These holes are numbered 2 in FIG. 1. This disk is given as an example only; there are other chamber parts that must be machined by the present method that are not simple disks. EDM tool 5 in FIG. 2 brings the electrical discharge to the ceramic part that is being machined numbered 7 in the drawing. The tool is usually spinning and water-cooled. The polarity of the electricity that it brings can be changed from positive to negative at the will of the machinist. The contact between the tool and the ceramic usually occurs in a bath of solution, which is agitated to remove particles from the machining process. The coolant may also flow through the tool for efficiency.

The PLASMA ETCHING CHAMBER PARTS MADE WITH EDM can machine many shapes in the ceramic materials besides round holes. The electrical lead 6 in FIG. 2 is the electrical supply voltage wire. Electrical lead 6 can be made to supply positive or negative polarity electricity. Electrical lead 9 in FIG. 2 is the return or ground electrical lead. Electrical lead 9 also may be electrically positive or negative. The clamp 8 in FIG. 2 is the clamp that holds down the ceramic piece 7, and it provides good electrical connection for the ceramic piece to the EDM machine. The hardness of this clamp 8 being less than Rockwell Hardness of 60 allows the effect of surface oxide on the ceramic to be minimized. In this way the surface oxide will not inhibit the free flow of electricity to the part. The clamp can be of softer material but the surface of the ceramic that the clamp will be seated on must be scrubbed with abrasive material to remove the oxide coating. The ceramic may have inhibiting layers that are not best typified by the name oxide. Whatever the chemical composition of the inhibiting layer, it must be removed or circumvented to allow the best results from the EDM machining. Materials that can be machined include silicon carbide, silicon, ferrites, and polycrystalline diamond. For the speed and accuracy of the EDM machining is greatly enhanced by the removal of the oxide or inhibiting layer on the ceramic. The mounting platform 10 in FIG. 2 is the surface that the ceramic rests on while it is being machined. Mounting platform 10 provides electrical contact between the ceramic and the EDM machine by way of the clamp labeled 8.

Other details of EDM machining are read in U.S. Pat. No. 5,498,848 by Kimihiro Wakabayashi and Noriyuki Nebashi, which teaches a METHOD AND APPARATUS FOR ELECTRIC DISCHARGE MACHINING, here included by reference. These details are of some interest, but with out proper clamping the EDM machining will be inhibited. The drawings provided in this disclosure are schematic only and actual equipment will have other features that are not necessary to the understanding of the present invention.

What we claim as our invention is:

1. A method for manufacturing chamber parts for plasma etching chambers composed of materials including silicon, silicon carbide, titanium nitride, ceramics, and other hard brittle materials that have sufficiently low resistivity for using electrical discharge machining (EDM) with good electrical contact between the machine and the material being machined.

2. An EDM as claimed in claim one where the metal clamp tooling has Rockwell Hardness of 60 or less.

3. An EDM as claimed in claim one where the metal clamp tooling is of metals of unspecified hardness that clamps on a surface of the ceramic has been abraded to remove surface inhibitors to the electrical contact.

4. An EDM as claimed in claim one where the metal clamp tooling is of metals of unspecified hardness that clamps on a surface of the ceramic that has been abraded to remove surface inhibitors to the electrical contact that are oxides.

5. Process is claimed for manufacturing plasma etching chamber parts that have low resistivities using electrical discharge machining where the clamping of the part to the machine allows good contact between the part being machined and the machine by maintaining the hardness of the clamp to below a Rockwell Hardness of 60.

6. Process is claimed for manufacturing plasma etching chamber parts that have low resistivities using electrical discharge machining where the clamping of the part to the machine allows good contact between the part being machined and the machine by cleaning the surface of the ceramic thoroughly that will make contact with the electrical discharge machine.
